(19) United States
(12) Patent Application Publication
(10) Pub. No.: US 2021/0211867 A1
(43) Pub. Date: Jul. 8, 2021

(54) ANONYMIZING WIRELESS MESSAGES

(71) Applicant: Pax Labs, Inc., San Francisco, CA (US)

(72) Inventors: Eric Amorde, Oakland, CA (US); Matthew Czapar, San Francisco, CA (US); Amanda Adams, San Francisco, CA (US); Pradyumna Upadhya, San Jose, CA (US); Michael Grobler, Redwood City, CA (US)

(21) Appl. No.: 16/790,609

(22) Filed: Feb. 13, 2020

Related U.S. Application Data
(60) Provisional application No. 62/957,093, filed on Jan. 3, 2020.

(51) Int. Cl. H04W 12/00; H04W 76/10; H04W 4/20; H04W 4/50; H04W 12/02; H04L 9/06

(52) U.S. Cl. CPC H04W 12/0013; H04W 76/10; H04W 4/20; H04W 4/50; H04L 2209/601; H04L 9/0618; H04L 2209/805; H04L 2209/88; H04L 2209/04; H04W 12/02

(57) ABSTRACT

Features relating to a vaporizer device configured to wirelessly broadcast anonymized advertisement messages to protect the privacy and/or security of a user of the vaporizer device and/or a user equipment.

### CROSS-REFERENCE TO RELATED APPLICATIONS

The present application claims priority to U.S. Provisional Application No. 62/957,093, filed on Jan. 3, 2020, and titled “Anonymizing Wireless Messages,” the entirety of which is incorporated by reference herein.

### TECHNICAL FIELD

The current subject matter described herein relates generally to vaporizer devices, such as portable, personal vaporizer devices for generating and delivering an inhalable aerosol from one or more vaporizable materials, and more particularly relates to messages sent by a personal vaporizer device.

### BACKGROUND

Vaporizing devices, including electronic vaporizers or e-vaporizers, allow the delivery of vapor and aerosol containing one or more active ingredients by inhalation of the vapor and aerosol. Electronic vaporizers are gaining increasing popularity both for prescriptive medical use, in delivering medicaments, and for consumption of nicotine, tobacco, other liquid-based substances, and other plant-based smokable materials, such as cannabis, including solid (e.g., loose-leaf or flower) materials, solid/liquid (e.g., suspensions, liquid-coated) materials, wax extracts, and prefilled pods (cartridges, wrapped containers, etc.) of such materials. Electronic vaporizers in particular may be portable, self-contained, and convenient for use.

### SUMMARY

According to some aspects, a method is provided. The method includes anonymizing at least a portion of an advertisement. The portion may include data identifying at least one of a vaporizer device and a user equipment associated with the vaporizer device. The method may also include transmitting to one or more devices including the user equipment, the anonymized advertisement.

In some aspects, the user equipment includes an application for configuring the vaporizer device. In some aspects, the vaporizer device may at least anonymize at least the portion of the advertisement by masking one or more fields of the advertisement while leaving at least one field of the advertisement in plaintext. In some aspects, the vaporizer device at least masks the one or more fields based on a cryptographic algorithm. The cryptographic algorithm may encrypt the one or more fields, cipher the one or more fields, scramble the one or more fields, and/or encode the one or more fields. The cryptographic algorithm may receive as an input, the one or more fields in plaintext and one or more shared keys, and the cryptographic algorithm may provide as an output, the one or more fields in cipher text.

In some aspects, the method further includes receiving a connection request from the user equipment. The method may also include establishing, in response to the connection request being received, a secure connection with the user equipment. The secure connection may be secured based on one or more locally stored shared keys. The one or more locally stored shared keys may be exchanged with the user equipment prior to the anonymized advertisement being transmitted by the vaporizer device.

In some aspects, the method also includes detecting a reset indication. The method may also include erasing, in response to the reset indication being detected, the one or more locally stored shared keys.

In some aspects, the reset indication includes a shaking gesture.

In some aspects, the one or more locally stored shared keys includes application layer shared keys.

In some aspects, the data identifying at least one of the vaporizer device and the user equipment associated with the vaporizer device includes an identifier of the vaporizer device, an identifier of a manufacturer of the vaporizer device, or a combination thereof.

In some aspects, to anonymize the advertisement, the vaporizer device may at least include an anonymized indicator in the advertisement.

In some aspects, the advertisement includes one or more of: a Bluetooth low energy advertisement, and a beacon.

Aspects of the current disclosure relate to anonymizing advertisement messages sent by a vaporizer device for increased user privacy and/or security.

According to some aspects, a method includes anonymizing at least a portion of an advertisement. The portion may include data identifying at least one of the vaporizer device and a user equipment associated with the vaporizer device. The method may also include broadcasting, to one or more devices including a user equipment, the anonymized advertisement message.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1A-FIG. 1B illustrate features of a vaporizer device including a vaporizer body and a cartridge, in accordance with some example embodiments;

FIG. 2 depicts a schematic block diagram illustrating features of a vaporizer device having a cartridge and a vaporizer body, in accordance with some example embodiments;

FIG. 3A depicts a message sequence associated with communications between a vaporizer device and a user equipment, in accordance with some example embodiments;

FIG. 3B depicts another message sequence associated with communications between a vaporizer device and a user equipment, in accordance with some example embodiments;

FIG. 4 depicts another message sequence associated with communications between a vaporizer device and a user equipment, in accordance with some example embodiments;

FIG. 5 depicts an anonymized advertisement message, in accordance with some example embodiments;

FIG. 6 depicts a flowchart for a message anonymizing process, in accordance with some example embodiments;

FIG. 7 depicts a flowchart for another message anonymizing process, in accordance with some example embodiments;

FIG. 8 depicts a flowchart for another message anonymizing process, in accordance with some example embodiments;

FIG. 9 depicts a flowchart for another message anonymizing process, in accordance with some example embodiments; and

FIG. 10 depicts a block diagram illustrating a computing system, in accordance with some example embodiments.

### DETAILED DESCRIPTION

Implementations of the current subject matter relate to advertisement messages wirelessly transmitted by a vaporizer device. The vaporizer device may be configured to vaporize one or more vaporizable materials for inhalation by a user. The term “vaporizer” may be used generically in the following description and may refer to a vaporizer device, such as an electronic vaporizer.

The vaporizer device may, from time to time, wirelessly transmit the advertisement messages to one or more devices including a user equipment, such as a smartphone, a tablet and/or the like. For example, the vaporizer device may transmit the advertisement messages as a broadcast to allow the user equipment to discover the vaporizer and then establish a wireless connection. In some embodiments, the user equipment may include an application, such as a mobile application (e.g., an “app”), that allows the mobile application to configure, monitor, and/or perform other operations to the vaporizer device.

Although these advertisement messages enable device discovery, the advertisement messages may include certain information that identifies the vaporizer device, the user equipment, and/or a user of the vaporizer device. For example, the vaporizer device may wirelessly broadcast an advertisement message, such as the advertisement messages used by Bluetooth, Bluetooth Low Energy, and other peer-to-peer wireless protocols. This advertisement message may include private or other information that the vaporizer device's user might not want share with a third party. However, an eavesdropping attack by a third party device may acquire the advertisement messages and view certain identifying data that can identify the vaporizer device, the user equipment, and/or the user. To address this privacy concern, there is provided anonymization of one or more advertisement messages, in accordance with some embodiments further described below.

In some embodiments, the vaporizer device may be configured to generate and wirelessly broadcast an advertisement (also referred to herein as advertisement message) having at least a portion of the advertisement anonymized. To generate the anonymized advertisement, the vaporizer device may replace certain information, such as the identifying data in the advertisement, with masked data. The masked data may refer to data that has been encrypted, enciphered, encoded, scrambled, or processed in other ways to obscure the identifying data and thus provide some degree of privacy. By masking the identifying data in the advertisement message, the vaporizer device may reduce or eliminate the possibility that a third party device's eavesdropping attack may view certain identifying data contained in the advertisement—enhancing thus the privacy of the vaporizer device, the user equipment, and/or the user.

Before providing additional details regarding the anonymization of advertisement messages, the following provides a description of some examples of vaporizer devices including a vaporizer body and a cartridge, although the anonymization of advertisement messages may be implemented with other types of vaporizer devices as well.

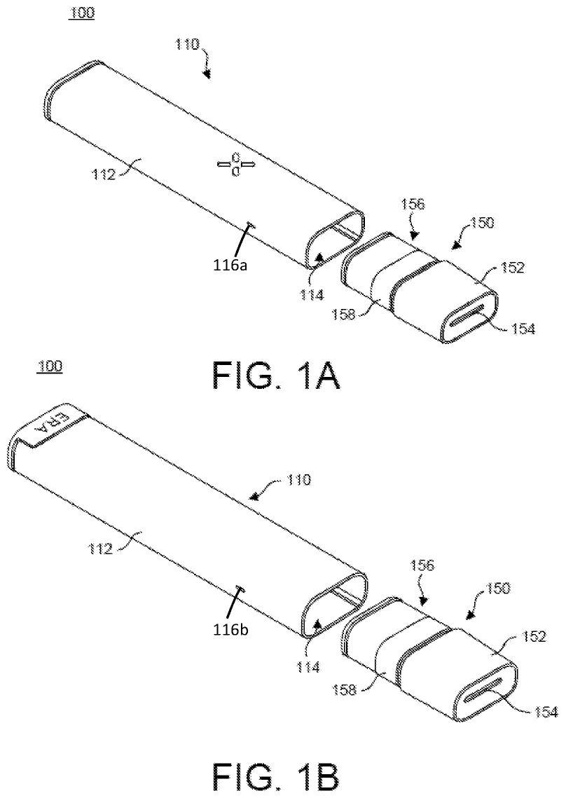

FIG. 1A-FIG. 1B illustrate an example of a vaporizer device 100 including a vaporizer body 110 and a cartridge 150 consistent with implementations of the current subject matter. FIG. 1A is a bottom perspective view, and FIG. 1B is a top perspective view of the vaporizer device 100 with the cartridge 150 separated from a cartridge receptacle 114 on the vaporizer body 110. Both of the views in FIG. 1A and FIG. 1B are shown looking towards a mouthpiece 152 of the cartridge 150.

As shown in FIG. 1A-FIG. 1B, the cartridge 150 includes, at the proximal end, a mouthpiece 152 that is attached over a cartridge body 156 that forms a reservoir or tank 158 that holds a vaporizable material. The cartridge body 156 may be transparent, translucent, opaque, or a combination thereof. The mouthpiece 152 may include one or more openings 154 at the proximal end, out of which vapor may be inhaled, by drawing breath through the vaporizer device 100. The distal end of the cartridge body 156 may couple to and be secured to the vaporizer body 110 within the cartridge receptacle 114 of the vaporizer body 110.

The vaporizer body 110 may have an outer shell or cover 112 that may be made of various types of materials, including for example aluminum (e.g., AL6063), stainless steel, glass, ceramic, titanium, plastic (e.g., Acrylonitrile Butadiene Styrene (ABS), Nylon, Polycarbonate (PC), Polyethersulfone (PESU), and the like), fiberglass, carbon fiber, and any hard, durable material.

The cartridge receptacle 114 portion of the vaporizer body 110 includes one or more openings (air inlets) 116a,b that extend through the outer shell 112 to allow airflow therein, as described in more detail below. The vaporizer body 110 as shown may have an elongated, flattened tubular shape that is curvature-continuous, although the vaporizer body 110 is not limited to such a shape. The vaporizer body 110 may take the form of other shapes, such as a rectangular box, a cylinder, or the like.

The cartridge 150 may fit within the cartridge receptacle 114 by a friction fit, snap fit, and/or other types of secure connection. The cartridge 150 may have a rim, ridge, protrusion, and/or the like for engaging a complimentary portion of the vaporizer body 110. While fitted within the cartridge receptacle 114, the cartridge 150 may be held securely within but still allow for being easily withdrawn to remove the cartridge 150.

Although FIG. 1A-FIG. 1B illustrate a certain configuration of the vaporizer device 100. The vaporizer device 100 may take other configurations as well.

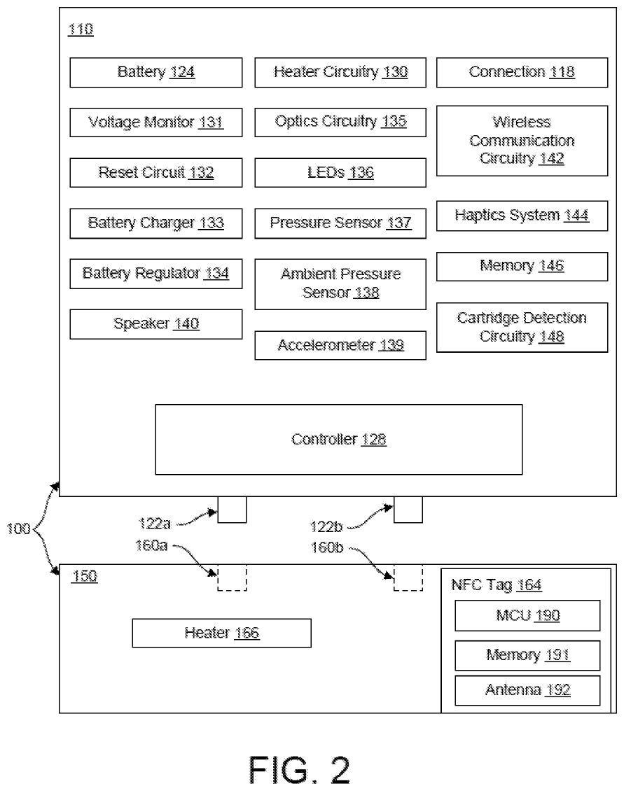

FIG. 2 depicts a schematic block diagram illustrating components of the vaporizer device 100 having the cartridge 150 and the vaporizer body 110, consistent with implementations of the current subject matter. The vaporizer body 110 includes a controller 128. The controller 128 may include at least one processor and/or at least one memory configured to control and manage various operations among the components of the vaporizer device 100 described herein.

The vaporizer body 110 may include a heater circuitry 130 that controls a heater 166 of the cartridge 150. The heater 166 may generate heat to provide vaporization of the vaporizable material.

The vaporizer body 110 may include a battery 124. The controller 128 may control and/or communicate with a voltage monitor 131 that includes circuitry configured to monitor the battery voltage, a reset circuit 132, a battery charger 133, and a battery regulator 134.

The vaporizer body 110 may include power pins 122a-122b. The power pins 122a-122b may engage the complementary power pin receptacles 160a-160b of the cartridge 150 when the cartridge 150 is engaged with the vaporizer body 110. The engagement allows for the transfer of energy from an internal power source (e.g., the battery 124) to the heater 166 in the cartridge 150. The controller 128 may regulate the power flow (e.g., an amount or current and/or a voltage amount) to control a temperature at which the heater 166 heats the vaporizable material contained in the reservoir 158.

The controller 128 may control and/or communicate with optics circuitry 135 which controls and/or communicates with one or more displays such as LEDs 136. The displays may provide user interface output indications. The controller 128 may control and/or communicate with a pressure sensor 137, an ambient pressure sensor 138, an accelerometer 139, and/or a speaker 140. The speaker 140 may be configured to generate sound or other feedback to a user of the vaporizer device.

The pressure sensor 137 may be configured to sense a pressure change due to the user drawing (e.g., inhaling) on the mouthpiece 152 and activate the heater control circuitry 130 of the vaporizer body 110 to accordingly control the heater 166 of the cartridge 150.

The accelerometer 139 (and/or other motion sensors, capacitive sensors, flow sensors, strain gauge(s), or the like) may be used to detect user handling and interaction, for example, to detect movement of the vaporizer body 110 (such as, for example, tapping, rolling, and/or other deliberate movements associated with the vaporizer body 110). The detected movements may be interpreted by the controller 128 as one or more predefined user commands.

The vaporizer body 110 may include wireless communication circuitry 142 connected to and/or controlled by the controller 128. The wireless communication circuitry 142 may include one or more circuitry for communication protocol standards, such as Bluetooth circuitry, Bluetooth Low Energy circuitry, Wi-Fi circuitry, cellular (e.g., LTE, 4G, and/or 5G) circuitry, and associated circuitry (e.g., control circuitry), for communication with other devices. For example, the vaporizer body 110 may be configured to communicate wirelessly with a remote processor (e.g., a smartphone, a tablet, a computer, wearable electronics, a cloud server, and/or processor-based devices) through the wireless communication circuitry 142. As noted above, the vaporizer body 110 may communicate via Bluetooth with a remote processor, such as the user equipment. Moreover, the Bluetooth circuitry or Bluetooth Low Energy circuitry may be configured to mask at least a portion of the advertisement message(s) that includes identifying data about the user of the vaporizer device and/or the vaporizer device itself.

The vaporizer body 110 may include a haptics system 144, such as an actuator, a linear resonant actuator (LRA), an eccentric rotating mass (ERM) motor, or the like that provides haptic feedback such as a vibration as a “find my device” feature or as a control or other type of user feedback signal.

The vaporizer body 110 may include a memory 146 that is part of the controller 128 and/or is in communication with the controller 128. The memory 146 may include volatile and/or non-volatile memory or provide data storage. In some implementations, the memory 146 may include 8 Mbit of flash memory, although other types of memory may be implemented as well.

Returning to anonymization of advertisement messages, the vaporizer device 100 may, from time to time, wirelessly transmit one or more advertisement messages as a broadcast to enable discovery by other devices and, in particular, a user equipment which can establish a connection with the vaporizer device. The user equipment, such as a smartphone, a tablet, and/or the like, may, as noted, include the mobile application as well. After discovering and connecting with the vaporizer device 100, the user equipment's mobile application may allow the user equipment (or its associated user) to configure, control, and/or monitor the vaporizer device 100.

In some embodiments, the advertisement message may be in accordance with a standard, such as Bluetooth, or Bluetooth Low Energy (BLE) as defined by, for example, Bluetooth Special Interest Group, Bluetooth Core Specification v5.1, Jan. 21, 2019, hereinafter the “Bluetooth Specification”). Although some of the examples herein refer to Bluetooth and/or Bluetooth Low Energy (collectively referred to as Bluetooth), other peer-to-peer technology or low-power wireless protocols may be used as well, such as low rate personal area networks, Zigbee, 6LoWPAN, SNAP, and the like as defined by IEEE 802.15.4v-2017—IEEE Standard for Low-Rate Wireless Networks—Amendment 5: Enabling/Updating the Use of Regional Sub-GHz Bands. Examples of an advertisement message include a Bluetooth advertisement, a Bluetooth Low Energy advertisement, a beacon, an IEEE 802.15.4 beacon, and/or other signals, beacons, or messages which may be used to wirelessly discover devices.

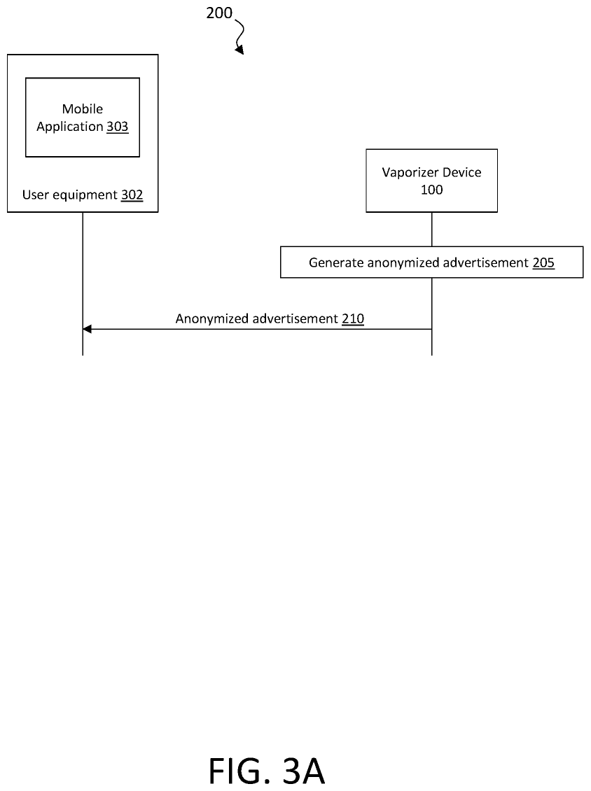

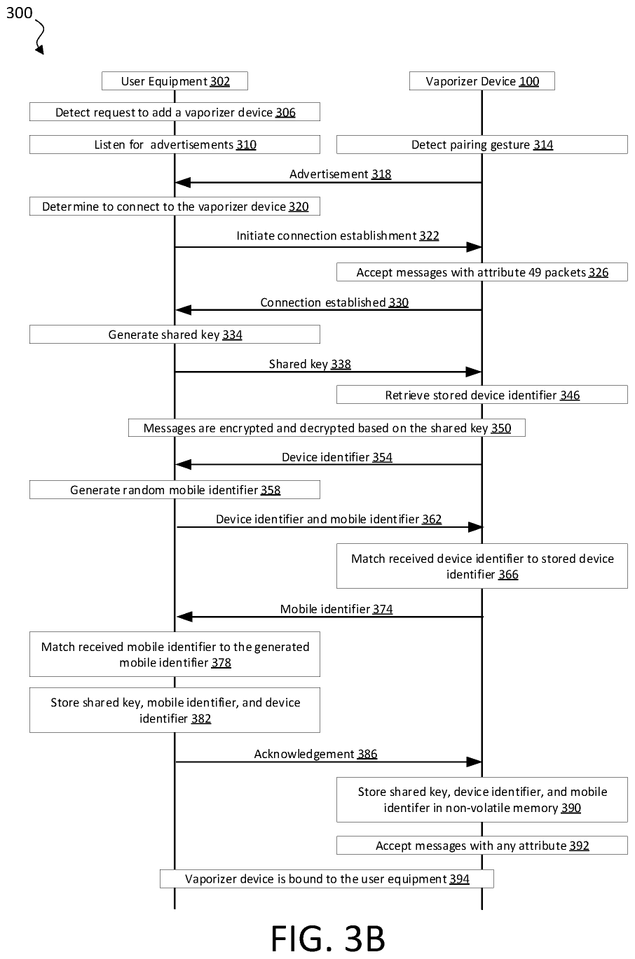

FIG. 3A depicts an example of a message sequence 200 between the vaporizer device 100 (including the vaporizer body 110 and/or the cartridge 150) and a user equipment 302, in accordance with some embodiments. The user equipment 302 may include a mobile application 303, which may be configured to control operational aspects of the vaporizer device 100 and/or receive information relating to operation of the vaporizer device 100 over a communications connection. For example, the mobile application 303 may provide a user with an ability to input or set desired properties or effects, such as, a particular temperature or desired dose, which is then communicated to the controller 128 of the vaporizer body 110 through the wireless communication circuitry 142. The mobile application 303 may also provide a user with functionality to select one or more sets of suggested properties or effects that may be based on the particular type of vaporizable material in the cartridge 150. The mobile application 303 may additionally and/or alternatively receive the user's input or set desired properties or effects, or the selected one or more sets of suggested properties or effects. For example, the mobile application 303 may allow adjusting heating (and/or receive an adjustment of the heating), based on the type of vaporizable material, the user's (of vaporizer device 100) preferences or desired experience, and/or the like. The mobile application may receive the user's input of the preferences or desired experience and/or the like.

During an initial pairing and/or binding process (e.g., as described with respect to FIG. 3B), the vaporizer device 100 may be paired with and/or be bound to the user equipment 302. The initial pairing and/or binding (e.g. virtual bonding) may be performed, for example, when the user purchases and/or obtains the vaporizer device 100 and/or the user equipment 302. The user may perform the initial pairing and/or binding in a private location, such as in the user's home or other location where the user may have a reasonable expectation of privacy. After the initial pairing and/or binding, the user may move to a more public space (e.g. an airport, or other publicly accessible facility) or other location where the user may not have an expectation of privacy. In the public space, there may be an increased risk of an eavesdropping attack on the communications between the user equipment 302 and the vaporizer device 100.

Upon completion of the initial pairing and/or binding, the vaporizer device 100 may become disconnected from the user equipment 302. The user equipment 302 may be turned off and on, the vaporizer device 100 may be turned off then on, the vaporizer device 100 may move out of radio range of the user equipment 302, and/or the like.

At 205, to increase the privacy and/or security of the vaporizer device 100 and/or the user of the vaporizer device 100 and/or user equipment 302, the vaporizer device 100 may generate an anonymized advertisement. The anonymized advertisement may reduce the possibility of a third party from discerning, from the advertisement, the identifying data included in the advertisement. To generate the anonymized advertisement, the vaporizer device 100 may mask portions of the advertisement that include identifying data, and not mask other portions of the advertisement that do not include identifying data. The masked data may refer to data that has been encrypted, enciphered, encoded, scrambled, or processed in other ways to obscure the identifying data and thus provide some degree of privacy. By anonymizing the advertisement at 205, the vaporizer device 100 may reduce the risk of a third party obtaining identifying data about the vaporizer device 100, the user equipment 302, and/or the user, thereby enhancing the privacy and/or security of the vaporizer device 100, the user equipment 302, and/or the user.

At 210, the vaporizer device 100 may, from time to time (e.g., periodically), transmit, via a broadcast for example, the advertisement including at least a portion of the advertisement anonymized at 205. The anonymized advertisement may include at least a portion that has been masked to protect the identifying data associated with the vaporizer device 100 and/or the user equipment 302. For example, the vaporizer device 100 including the wireless communication circuitry 142 may broadcast the anonymized advertisement to one or more other devices, including the user equipment 302 (with which the vaporizer device 100 was previously paired and/or bound). By broadcasting the advertisement, the vaporizer device 100 may allow the devices to discover and/or detect the presence of the vaporizer device 100. In response, the user equipment 302 may re-establish communication with the vaporizer device 100.

Turning now to an initial pairing and/or binding process consistent with implementations of the current subject matter, FIG. 3B depicts an example of a message sequence 300 between the vaporizer device 100 (including the vaporizer body 110 and the cartridge 150) and the user equipment 302, in accordance with some embodiments.

At 306, the user equipment 302 may detect a request to add a vaporizer device. The user may indicate this request by selecting a menu item, by pressing a button, by making a gesture, and/or the like.

At 310 the user equipment 302 may listen for advertisements. The user equipment 302 may listen for advertisements in response to detecting the request at 306. In the case of Bluetooth Low Energy, the user equipment 302 may listen for Bluetooth Low Energy advertisements.

At 314, the vaporizer device 100 may detect a pairing gesture. For example, the user input may be a predefined input motion. The pairing gesture may be performed by the user by for example moving the vaporizer device for a predetermined time or in a predetermined motion. The vaporizer device 100 may detect the pairing gesture using a sensor, such as the accelerometer. If the pairing gesture is a shaking gesture, for example, the vaporizer device 100 may recognize shaking the vaporizer device 100 for a period of time, such as 0.25 seconds, 0.5 seconds, 0.75 seconds, 1 second, 2 seconds, 2.25 seconds, 2.5 seconds, 2.75 seconds, 3 seconds, 3.25 seconds, 3.5 seconds, 3.75 seconds, 4 seconds, 4.25 seconds, 4.5 seconds, 4.75 seconds, 5 seconds, 5.25 seconds, 5.5 seconds, 5.75 seconds, 6 seconds, or more, and other predetermined time intervals. In some embodiments, the predetermined time interval is at least 2 seconds to distinguish the pairing gesture from other motion gestures and/or motions that may be detected by the vaporizer device 100. The pairing gesture may include shaking the vaporizer device 100 back and forth repeatedly, rotating the vaporizer device 100 about an axis along the device, or some other predetermined motion.

At 318, the vaporizer device 100 may wirelessly transmit (as a broadcast, for example) one or more advertisements. For example, the vaporizer device including the wireless communication circuitry 142 may transmit from time to time (e.g., periodically) one or more advertisements in accordance with Bluetooth or Bluetooth Low Energy (collectively referred to as Bluetooth). The broadcast of the advertisement allows the vaporizer device to be discovered by another device, such as the user equipment 302. The advertisement may include, as noted, identifying data associated with the vaporizer device 100, the user equipment 302, and/or a user.

Table 1 shows examples of identifying data that may be included in an advertisement message wirelessly broadcast by the vaporizer device 100. In the example of Table 1, the AD Type/GATT Handle column corresponds to a type of data as further described in the Bluetooth Specification. As can be seen from Table 1, there are one or more data elements about the vaporizer device and/or user equipment, which may be anonymized to provide enhanced privacy.

TABLE 1
Examples of identifying data in a Bluetooth advertisement.

| AD Type/GATT | | |
|---|---|---|
| Handle | Field Name | Identifying Data |
| 0x08 | Shortened Local Name | Name of the device, e.g., |
| | | “PAX 3” |
| 0x09 | Complete Local Name | Name of the device, e.g., |
| | | “PAX 3” |
| 0x10 | Device ID | Manufacturer identifier |
| 0x24 | URI | Company domain name |
| 0x2A24 | Model Number String | Model number |
| 0x2A25 | Serial Number String | Serial number |
| 0x2A28 | Software revision string | Software version number |

In response to receiving the advertisement at 318, the user equipment 302 (or the mobile application 303 therein) may determine, at 320, to connect to the vaporizer device. This determination may be based on the contents of the advertisement message (e.g., the identifying data contained in the advertisement or other data in the advertisement). The user equipment 302 may determine that the advertisement includes a serial number, a model number, manufacturer-specific data, and/or other information that the user equipment 302 recognizes as conforming to an expected format, value, and/or range of values. The user equipment 302 may display at least some of the identifying data from the advertisement on a user interface display. The user equipment 302 may detect a user selection to connect to the vaporizer device 100. The user equipment 302 may locally store at least some of the identifying data included in the advertisement. For example, if the advertisement includes a device serial number, the user equipment 302 may locally store the device serial number. As will be described further, the user equipment 302 may later determine, based on the locally stored identifying data, whether to re-establish a connection with the vaporizer device 100.

To illustrate further with a Bluetooth example, the user equipment 302 may receive, at 318, a Bluetooth advertisement from the vaporizer device 100. As shown in Table 1, the Bluetooth advertisement may include one or more elements that identify the vaporizer device and the user of the user equipment and associated vaporizer device. The user equipment 302 may compare the identifying data (as well as other data) from the advertisement to determine whether to connect (e.g., pair) with the vaporizer device 100. For example, if the identifying data indicates a serial number, a model number, certain manufacturer-specific data, certain service universally unique identifiers (UUIDs), and or the like that conform to an expected format and/or expected value, the user equipment may decide to establish a Bluetooth connection and/or pair with the vaporizer device. If the user equipment decides, at 320, to connect to with the vaporizer device 100, the user equipment 302 may locally store at least some of the contents of the Bluetooth advertisement, such as the device serial number, model number, manufacturer data, and/or other data elements received in the Bluetooth advertisement. The user equipment 302 may determine, based on the locally stored identifying data, whether to re-establish communication with the vaporizer device 100.

At 322, the vaporizer device 100 may initiate establishment of a connection with the user equipment 302. In response to determining to connect (e.g., pair) with the vaporizer device at 320, the user equipment 302 may initiate connection establishment by at least sending a connection request message to the vaporizer device 100. In the case of Bluetooth for example, the user equipment 302 may send, at 322, a Bluetooth connection request to the vaporizer device 100. The Bluetooth connection request may be a Bluetooth CONNECT_REQ message responsive to the Bluetooth advertisement received at 318.

At 326, the vaporizer device 100 may accept messages that include certain attributes and/or parameters. In the Bluetooth example, the vaporizer device may accept messages that include a pairing key attribute, such as attribute 49. The pairing key attribute may indicate the message includes other attributes and/or parameters, such as a shared key, a pairing key, and/or the like.

At 330, the vaporizer device 100 and the user equipment 302 may establish a connection. In the case of Bluetooth, the user equipment 302 may send one or more messages during a pairing process, such as Bluetooth pairing request messages. In response, the vaporizer device 100 may send one or more messages, such as Bluetooth pairing response messages.

At 334, the user equipment 302 may generate a shared key. The shared key may be of any length, including 2 bits, 4 bits, 8 bits, 16 bits, 32 bits, 64 bits, or longer. As will be described, the shared key may be used for cryptographic encryption and decryption of wireless messages and/or the contents thereof sent by the user equipment 302 and the vaporizer device 100. As such, the shared key may be used to mask identifying information found in advertisements sent by the vaporizer device 100.

At 338, the user equipment 302 may send the shared key to the vaporizer device 100. The shared key may be stored locally at the vaporizer device 100 and at the user equipment 302. The shared key may be used to provide secure communications over the connection established at 330 between the vaporizer device 100 and the user equipment 302. The shared key may refer to at least one cryptographic key used by a cryptographic algorithm to encrypt and/or decrypt data. The shared key may be valid for a period of time, such as over a period of one or more sessions between the vaporizer device 100 and the user equipment 302. Alternatively or additionally, the shared key may be valid for secure communications over the connection established at 330 until the vaporizer device and/or the user equipment invalidate, discard, and/or erase the locally stored shared key. Alternatively, or additionally, the shared key may be valid for secure communications over the established connection 330 until the user equipment 302 sends a new shared key to the vaporizer device 100. In the case of Bluetooth, the user equipment 302 may send the shared key to the vaporizer device 100 in a message that includes a pairing key attribute, such as attribute 49. The shared key may enable the vaporizer device 100 and the user equipment 302 to establish a secure a Bluetooth connection. This secure connection may be established across multiple sessions of connections and re-connections, without having to generate and send a new shared key.

At 346, the vaporizer device 100 may retrieve a device identifier (e.g., from local and/or non-volatile memory). The device identifier may identify the vaporizer device 100 from among other vaporizer devices with which the user equipment 302 may come into radio range. In the case of Bluetooth, the device identifier may be referred to as a Bluetooth device address (BD_ADDR). The device identifier may be a 48 bit value, that includes identifying information about the manufacturer and a device-specific media access control (MAC) address. As will be described, the vaporizer device 100 and the user equipment 302 may later use the device identifier to re-establish communications.

Starting at 350, communications between the user equipment 302 and the vaporizer device 100 may be secured based on the shared key. In the case of Bluetooth for example, the vaporizer and user equipment may secure (e.g., via encryption and decryption based on the shared key) at least some (if not all) of the data exchanged via the Bluetooth connection established at 330. The encryption and decryption may be applied to the entire payload of each Bluetooth packet. Alternatively, and/or additionally, the encryption and decryption may be applied to the Bluetooth services at the vaporizer device 100 and/or the user equipment 302.

At 354, the vaporizer device 100 may send the device identifier to the user equipment 302 to continue the binding process.

At 358, the user equipment 302 may generate a random mobile identifier. The mobile identifier may be of sufficient length to allow the vaporizer device 100 to uniquely identify the user equipment 302 from among other user equipment with the vaporizer device may later come into radio range. The mobile identifier may be 16 bits, 32 bits, 64 bits, or other lengths.

At 362, the user equipment 302 may send the device identifier and the mobile identifier to the vaporizer device 100. By sending the device identifier back to the vaporizer device 100, the user equipment 302 confirms that it successfully received the device identifier.

At 366, the vaporizer device 100 may match the received device identifier received with the stored device identifier. If the device identifiers match, at 374 the vaporizer device 100 may send the received mobile identifier back to the user equipment 302. By sending the mobile identifier back to the user equipment 302, the vaporizer device confirms that it successfully received the mobile identifier.

At 378, the user equipment 302 may match the received mobile identifier against the generated mobile identifier. If the mobile identifiers match, at 382 the user equipment 302 may locally store the shared key, mobile identifier, device identifier, and/or other parameters related to the vaporizer device 100 and/or the connection to the vaporizer device 100.

Any number of vaporizer devices may be bound to the user equipment 302 at any given time. As such, the user equipment 302 may store (e.g., locally and/or in non-volatile memory), a binding record associated with each vaporizer device. Each binding record (e.g. association, association information, binding information, virtual bonding information, and/or the like) may include a shared key, a device identifier, a mobile identifier, and/or other identifying information about the vaporizer device 100. For example, if two vaporizer devices are bound to the user equipment 302, the user equipment 302 may store a first binding record associated with the first vaporizer device and a second binding record associated with the second vaporizer device. The first binding record may include a first shared key, a first device identifier, a first mobile identifier, and/or the like. Similarly, the second binding record may include a second shared key, a second device identifier, a second mobile identifier, and/or the like. As noted, any number of vaporizer devices may be bound to the user equipment 302. As such, the user equipment 302 may include any number of binding records, each associated with a different vaporizer device.

At 386, the user equipment 302 may send an acknowledgement to the vaporizer device 100. By sending the acknowledgement, the user equipment 302 indicates to the vaporizer device 100 that binding is complete. As used herein, binding may refer to a process used to exchange certain parameters between the vaporizer device 100 and the user equipment 302 in order to bind the vaporizer device 100 to the user equipment 302. The parameters used to bind vaporizer device 100 to the user equipment 302 may include the device identifier (e.g., of the vaporizer device 100), the mobile identifier (e.g., generated by the user equipment), the shared key, and/or other parameters related to the user equipment 302, the vaporizer device 100, and/or the connection between them.

At 390, the vaporizer device 100 may locally store the shared key, device identifier, mobile identifier, and/or other binding parameters (e.g., in non-volatile memory). The vaporizer device 100 and the user equipment 302 may use these parameters to re-establish communications.

At 392, the vaporizer device 100 may accept messages that include any kind of attributes. The attributes may include attributes that control the function and/or appearance of the vaporizer device 100. Attributes may include heater set point attributes, color theme attributes, name attributes, session size attributes, dosage attributes, and/or the like.

At 394, the vaporizer device 100 may be considered bound to the user equipment 302. After the vaporizer device 100 is bound to the user equipment 302, the vaporizer device 100 may be configured to only establish communications with the user equipment 302 until the binding between the vaporizer device 100 and the user equipment 302 is ended. The binding between the user equipment 302 and the vaporizer device 100 may end when the vaporizer device detects a pairing gesture and/or a reset indication.

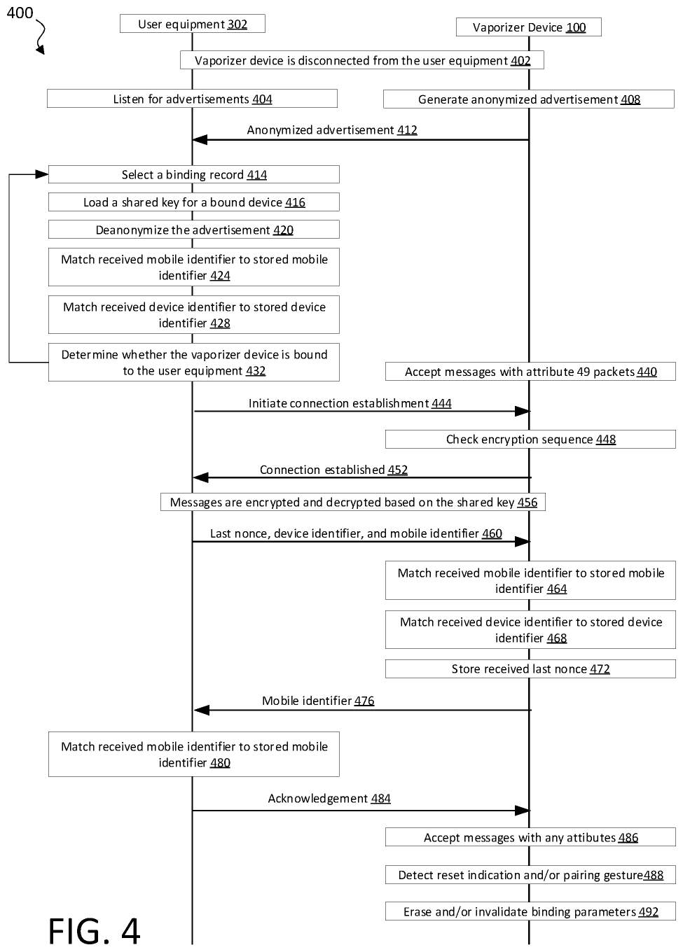

After pairing and/or binding the vaporizer device 100 to the user equipment 302, the user may move to location where there is an increased risk of an eavesdropping attack. As shown in FIG. 4, if the vaporizer device 100 becomes disconnected from the user equipment 302, the vaporizer device 100 may broadcast anonymized advertisements. The anonymized advertisements may allow the user equipment 302 to re-discover and re-establish communication with the vaporizer device 100 while increasing the privacy and/or security of the user.

Returning now to the generation and the broadcasting of anonymized advertisements (as briefly discussed above with respect to FIG. 3A), FIG. 4 depicts an example of a message sequence 400 between the vaporizer device 100 and the user equipment 302, in accordance with some embodiments.

At 402, the vaporizer device 100 may become disconnected from the user equipment 302. For example, the vaporizer device may be powered off and then on, the user equipment may be powered off, the user equipment 302 may move out of range of the vaporizer device, or for other reasons causing a loss of the Bluetooth connection, for example.

At 404, the user equipment 302 may listen for advertisements. In the case of Bluetooth Low Energy, the user equipment 302 may listen for Bluetooth Low Energy advertisements. The user equipment 302 may listen for advertisements when the mobile application 303 is launched at the user equipment 302. Alternatively, and/or additionally, the user equipment 302 may begin listening for advertisements in response to receiving an input from the user. The user may provide the indication via a user interface menu selection, button press, touch screen event, and/or the like. Alternatively, and/or additionally, the user equipment 302 may start listening for advertisements when a Bluetooth service is turned on at the user equipment 302.

When the vaporizer device 100 and, in particular, the wireless communication circuitry 142 detects the disconnected state at 402, the vaporizer device may determine a need to initiate transmission of one or more advertisements to enable discovery by other devices and, in particular, by the user equipment 302. Alternatively, and/or additionally, the vaporizer device 100 may detect a shaking gesture and, in response, determine a need to initiate transmission of one or more advertisements to enable discovery by the other devices. During the time the vaporizer device 100 is broadcasting advertisements, a third party may, as noted, eavesdrop on the one or more advertisement to obtain identifying data from the one or more advertisements. For example, the third party may use a scanner to acquire, from a Bluetooth advertisement, identifying data included in any of the Bluetooth elements listed in Table 1. The third party may use the identifying data to identify and/or narrow down the identity of the vaporizer device 100, the user equipment 302, and/or the user of the vaporizer device 100. Referring to Table 1, the vaporizer device 100 may send advertisements that include the Device ID (0x10), Serial Number String (0x2A25), Model Number String (0x2A24) elements, and/or the like. These elements may contain identifying data that can be used to identify the vaporizer device. For example, the vaporizer device 100 may send advertisements that include a URI (0x24) element. The URI element may include a uniform resource identifier, which may include the Internet domain name of the manufacturer, such as “pax.com.” The vaporizer device 100 may send advertisements that include other identifying data about the vaporizer device 100 and/or the user of the vaporizer device 100, including a mobile identifier, a device identifier, a service universally unique identifier (UUID), a device serial number, manufacturer-specific data, and/or the like.

To increase the privacy and security of the vaporizer device 100 and/or the user of the vaporizer device 100 and/or user equipment 302, during connection re-establishment with the user equipment 302, the vaporizer device 100 may, at 408, generate an anonymized advertisement. The anonymized advertisement may prevent a third party from discerning, from the advertisement, the identifying data included in the advertisement.

At 408, in some embodiments, the vaporizer device 100 may anonymize at least a portion of the contents of the advertisement by masking (e.g., encrypting, ciphering, obscuring, encoding, scrambling, and/or the like), while leaving as plaintext (e.g., not masked) at least one other portion of the advertisement. For example, the vaporizer device may generate the advertisement such that the advertisement includes as cipher text at least one portion and includes, as plaintext, at least one other portion such as battery level, date and time, random address, floor number, humidity, or other data that does not identify the vaporizer device 100, the user equipment 302, and/or a user thereof.

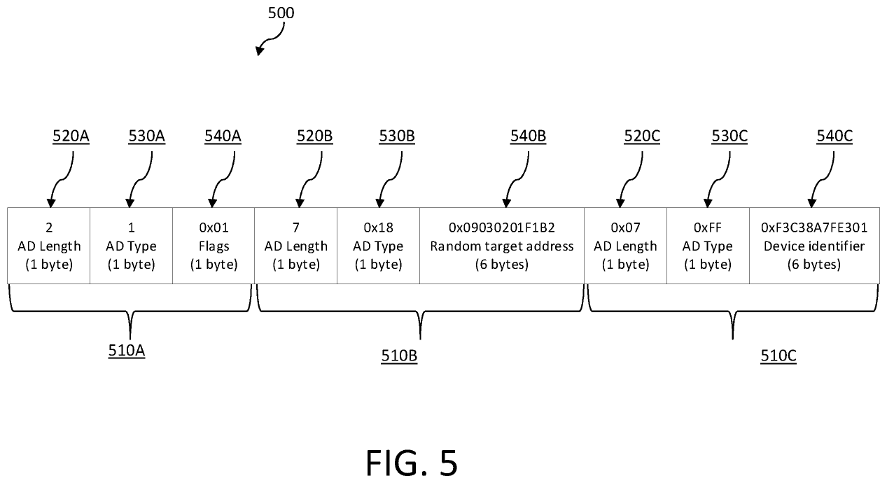

FIG. 5 depicts an example of a Bluetooth advertisement message 500 which is anonymized, in accordance with some example embodiments. The advertisement message 500 may include three Bluetooth elements, 510A-C. Each element 510A-C may include a length field 520A-C, an Advertisement Data (AD) type field 530A-C, and a data field 540A-C. The first element 510A includes flags 540A, which, because it does not include identifying data, may be sent as plaintext (e.g., not masked). The second element 510B includes a random target address 540B, which, because it does not include identifying data, may be sent as plaintext. The third element 510C includes an AD Type of 0xFF, which indicates the element 510C contains manufacturer specific data. The third element 540C contains a 48 bit (6 byte) device identifier of the vaporizer device. The device identifier 540C may be masked because it includes identifying data. If the device identifier string 540C was not masked by the vaporizer device, a third party (e.g., using a scanner) may acquire the device identifier from that element and use the device identifier to identify the vaporizer device, the user, and/or the user equipment. The other fields of the advertisement 500 (e.g., the flags 540A and the random target address 540B) may be kept in plaintext (e.g., not masked) because they do not contain identifying data. In the example of FIG. 5, to anonymize the advertisement message 500, the vaporizer device may mask the identifying data in the field 540C, but include the unmasked data as plaintext for the other fields 520A-C, 530A-C, and 540A-B.

Returning to FIG. 4, at 408, the vaporizer device 100 may, as noted, generate an anonymized advertisement by masking at least a portion of the identifying data in the advertisement. To mask the identifying data, the vaporizer device 100 may apply one or more cryptographic algorithms. Although the following describes masking a portion of the advertisement (e.g., 540C of advertisement 500 at FIG. 5 as well as other portions or data elements) using a cryptographic algorithm, such as encryption, the masking algorithm and/or cryptographic algorithm may include other techniques such as ciphering, encoding, bit scrambling, hashing, and/or the like.

The vaporizer device 100 may apply the cryptographic algorithm to encrypt the identifying data included in the advertisement. The inputs to the cryptographic algorithm may include the plaintext of identifying data and/or the shared key, while the output of the cryptographic algorithm may include a ciphertext of the identifying data. For example, a 6 byte value in plaintext of 540C (FIG. 5) and the shared key (which was received at 338) may be provided as an input to the cryptographic algorithm, which outputs a ciphertext (e.g., encrypted) representation of that 6 byte value. The vaporizer device 100 may insert this ciphertext into the anonymized advertisement at 540C. For example, the vaporizer device 100 may replace, in the advertisement 500, the plaintext 6 byte value at 540C with the ciphertext representation of that 6 byte value at 540C. If the advertisement includes other elements that include identifying data, the vaporizer device may encrypt and replace those elements as well before broadcasting the advertisement.

To illustrate further with a Bluetooth advertisement example of FIG. 5, the plaintext of the device identifier may be the 6 byte value 0x123456789012. In this example, the vaporizer device 100 may encrypt the device identifier to produce a ciphertext, such as 0xF3C38A7FE301. The vaporizer device may include the ciphertext of the identifying data in the device identifier field 540C of the Bluetooth advertisement before broadcasting the advertisement.

Referring again to FIG. 4, to generate the anonymized advertisement, the vaporizer device 100 may apply the shared key previously received, as described above with respect to 338. The vaporizer device 100 and the user equipment 302 may exchange other key(s) after the binding is complete. For example, these other key(s) may be application-layer shared key. When this is the case, the vaporizer device 100 may apply, at 408, the application-layer shared key to mask, via encryption, the identifying data in the advertisement prior to broadcasting the advertisement.

The cryptographic algorithm implemented at the vaporizer 100 (e.g., at the controller 128, wireless circuitry 142, and/or in other portions of the vaporizer 100) may include a symmetric algorithm or an asymmetric algorithm. Examples of an asymmetric algorithm include Diffie-Hellman, RSA, ECC, and DSA. Examples of a symmetric algorithm include AES, AES-256-CT, RC4-6, and DES.

As noted, the identifying data may be masked based on cryptographic algorithm providing a cipher algorithm. When ciphering is used for example, the vaporizer device 100 may apply a substitution cipher to mask the identifying data in the advertisement. Alternatively or additionally, the cryptographic algorithm may scramble the order of the identifying data in the advertisement in a predetermined way which may be descrambled by the user equipment 302. Alternatively, and/or additionally, to mask the identifying data in an advertisement, the cryptographic algorithm may apply an encoding algorithm to the identifying data to produce a ciphertext. For example, the vaporizer device 100 may apply a base 64 encoding (e.g., ROT64) to mask the identifying data in the advertisement.

At 412, the vaporizer device 100 may transmit, via a broadcast for example, the advertisement including at least a portion of the advertisement anonymized at 408. This anonymized advertisement may include at least the portion that has been masked, to make private, identifying data associated with the vaporizer device 100 and/or the user equipment 302. For example, the vaporizer device 100 including the wireless communication circuitry 142 may broadcast the anonymized advertisement to one or more other devices including the user equipment 302 (with which the vaporizer device 100 was previously paired and/or bound).

At 414, the user equipment 302 may select a binding record (e.g., from local and/or non-volatile memory). As noted, any number of vaporizer devices may be bound to the user equipment 302 at any given time, so the user equipment 302 may locally store any number of binding records. Each binding record may be associated with a different vaporizer device. Each binding record may include a shared key, device identifier, mobile identifier, and/or other parameters associated with the binding. To deanonymize the received advertisement, the user equipment 302 may select a locally stored binding record.

At 416, the user equipment 302 may load a shared key from the selected binding record. For example, the user equipment 302 may have binding records for three vaporizer devices. If, as described above with respect to 414, the first binding record is selected, the shared key associated with the first binding record may be loaded.

At 420, the user equipment 302 may deanonymize the received advertisement message based on the shared key from the selected binding record. To deanonymize the advertisement, the user equipment 302 may unmask at least a portion of the anonymized advertisement received at 412. For example, the user equipment may unmask the identifying data in one or more fields of the advertisement by decrypting, deciphering, and/or the like the field(s) masked by the vaporizer device as described above with respect to 408. To unmask the identifying data from the advertisement, the user equipment may apply an unmasking technique that corresponds to the masking technique applied by the vaporizer device 100 to mask the identifying data at 408.

If the vaporizer device applies a cryptographic algorithm to mask, by encryption, the identifying data in the advertisement for example, the user equipment 302 may apply a reciprocal cryptographic algorithm to unmask (e.g., decrypt) those portions of the advertisement that have been anonymized at 408 to reveal the plaintext representation of the identifying data. The inputs to the cryptographic algorithm may include the ciphertext (e.g., the encrypted identifying data) from the advertisement and/or the shared key. The output of the decryption algorithm may include the plaintext of the identifying data (e.g., the unmasked or decrypted identifying data). Alternatively, and/or additionally, the cryptographic algorithm at the user equipment may apply a de-ciphering algorithm to unmask at least a portion of the advertisement to produce the unmasked identifying data and/or apply a decoding algorithm to produce the unmasked identifying data. Returning to the example of FIG. 5, the user equipment 302 may apply the cryptographic algorithm to deanonymize or unmask those portions of the advertisement that have been masked, such as the device identifier at 540C, while portions of the advertisement that do not include identifying data (and as such have not been anonymized by the vaporizer device) would not be processed with the cryptographic algorithm in order to be unmasked.

As noted above with respect to 346 (see FIG. 3B), the vaporizer device 100 may have a locally stored device identifier. The device identifier may uniquely identify the vaporizer device 100. In the case of Bluetooth, the device identifier may be a 48 bit value that includes identifying information about the manufacturer.

At 358 (see FIG. 3B), the user equipment 302 may generate a mobile identifier, at 362, the user equipment 302 may send the mobile identifier to the vaporizer device 100, and at 390, the vaporizer device 100 may locally store the mobile identifier (e.g., in non-volatile memory). As such, the user equipment 302 and the vaporizer device 100 may each have a locally stored device identifier that identifies the vaporizer device 100.

Additionally, and/or alternatively, the user equipment 302 and the vaporizer device 100 may each have a locally stored mobile identifier that can be used to identify the user equipment 302. The device identifier, the mobile identifier, and/or the shared key may be stored at the user equipment 302 and/or at the vaporizer device 100.

Referring again to FIG. 4, at 424, the user equipment 302 may match a mobile identifier received in the anonymized advertisement at 412 with a mobile identifier from the selected binding record. If the mobile identifiers match, at 428 the user equipment 302 may match a device identifier received in the anonymized advertisement with the device identifier from the selected binding record.

At 432, the user equipment 302 may determine whether the vaporizer device 100 is bound to the user equipment 302. If the received identifying data is different from the locally stored identifying data, the user equipment 302 may determine that the advertisement was received from a vaporizer device other than the one associated with the selected binding record. As such, the user equipment 302 may try deanonymizing the received advertisement using a shared key from different binding record by selecting a different binding record, as described above with respect to 414. For example, if the user equipment 302 determines that the device identifier obtained from the received advertisement is different from the device identifier from the selected binding record, the user equipment 302 may continue by selecting a different binding record as described above with respect to 414. Alternatively, and/or additionally, if the user equipment 302 determines that the mobile identifier from the received advertisement is different than the mobile identifier from the selected binding record, the user equipment 302 may continue by selecting a different binding record as described above with respect to 414. On the other hand, if the received identifying data matches the locally stored identifying data, the user equipment 302 may determine, at 440, that the vaporizer device 100 is bound to the user equipment 302. For example, if the user equipment 302 determines that the received device identifier and the received mobile identifier match the respective values from the selected binding record, the user equipment 302 may determine that the vaporizer device 100 is bound to the user equipment 302.

At 440, the vaporizer device 100 may accept messages that contain specific attributes and/or parameters. In the Bluetooth example, the vaporizer device 100 may accept messages that include a pairing key attribute, such as attribute 49. As noted, the pairing key attribute may indicate the message includes other attributes and/or parameters, such as a shared key, a pairing key, and/or the like.

If, as described above with respect to 432, the user equipment 302 determines that the vaporizer device 100 is bound to the user equipment 302, at 444, the user equipment 302 may initiate establishment and/or re-establishment of a connection with the vaporizer device 100. In the case of Bluetooth for example, the user equipment 302 may send a Bluetooth low energy CONNECT_REQ message to the vaporizer device 100 in response to the Bluetooth advertisement received at 412.

At 448, the vaporizer device 100 may check the encryption sequence. To check the encryption sequence, the vaporizer device 100 may compare attributes and/or parameters exchanged between the user equipment 302 and the vaporizer device 100. Checking the encryption sequence may include comparing last nonces, device identifiers, mobile identifiers, and/or the like.

At 452, a connection may be established and/or re-established between the user equipment 302 and the vaporizer device 100. In the case of Bluetooth, the vaporizer device 100 may send a Bluetooth low energy CONNECTION_RESP message to the user equipment 302. Because the vaporizer device 100 is bound to the user equipment 302, starting at 456 the connection between the user equipment 302 and the vaporizer device 100 may be secured based on the shared key. As noted, in the case of Bluetooth for example, the vaporizer 100 and user equipment 302 may secure (e.g., via encryption and decryption based on the shared key) at least some (if not all) of the data exchanged via the Bluetooth connection established at 452. As such, the encryption and decryption may be applied to the entire payload of each Bluetooth packet. Alternatively, and/or additionally, the encryption and decryption may be applied to the Bluetooth services at the vaporizer device 100 and/or the user equipment 302.

At 460, the user equipment 302 may send a last nonce, device identifier, and/or mobile identifier to the user equipment. As described above with respect to 416, the device identifier and mobile identifier may have been received in the advertisement at 412. The last nonce may be a 128-bit value initialized to zero. The nonce may be one of the inputs to an encryption algorithm, such as AES-CTR or AES-256-CTR. The user equipment 302 may maintain a last nonce for each encryption key, such as a last nonce for each vaporizer device 100 bound to the user equipment 302. The user equipment 302 may increment the last nonce each time a new packet is sent. The user equipment 302 may use the last nonce to detect an out-of-sequence packet received from the vaporizer device 100.

At 464, the vaporizer device 100 may match the received mobile identifier with the locally stored mobile identifier. If the mobile identifiers match, at 468 the vaporizer device 100 may match the received device identifier with the locally stored device identifier. If the vaporizer device 100 determines that the received mobile identifier and the received device identifier match the locally stored values, the vaporizer device 100 may determine that the user equipment 302 is the same user equipment that the vaporizer device 100 previously paired with and/or bound to, as described above with respect to FIG. 3.

At 472, the vaporizer device 100 may store the received last nonce (e.g., locally and/or in non-volatile memory). As noted above with respect to 460, the last nonce may be one of the inputs to an encryption algorithm. The vaporizer device 100 may increment the last nonce each time a new packet is sent. The vaporizer device 100 may use the last nonce to detect an out-of-sequence packet received from the user equipment 302.

At 476, the vaporizer device 100 may send the mobile identifier to the user equipment 302. By sending the mobile identifier to the user equipment 302, the vaporizer device 100 may confirm that it is bound to the user equipment 302.

At 480, the user equipment 302 may match the mobile identifier received at 476 with the locally stored mobile identifier. As noted above with respect to 416, the locally stored mobile identifier may be included in a binding record, along with the device identifier, shared key, and other identifying data. If the user equipment 302 determines that the received mobile identifier matches the locally stored mobile identifier, the user equipment 302 may determine that the vaporizer device 100 is bound to the user equipment.

At 484, the user equipment 302 may send an acknowledgement to the vaporizer device 100. By sending the acknowledgement, the user equipment 302 may confirm to the vaporizer device 100 that the vaporizer device 100 is bound to the user equipment 302.

At 486, the vaporizer device 100 may accept messages containing any attribute. As noted, the attributes may include any attribute that controls the function and/or appearance of the vaporizer device 100. As such, attributes may include heater set point attributes, color theme attributes, name attributes, session size attributes, dosage attributes, and/or the like.

At 488, the vaporizer device 100 may detect a reset indication and/or pairing gesture. The reset indication and/or pairing gesture may indicate the termination of the binding and/or pairing between the user equipment 302 and the vaporizer device 100. The reset indication and/or erase gesture may include a notification and/or message from the user equipment 302. Alternatively, and/or additionally, the reset indication and/or pairing gesture may be a user input at the vaporizer device 100.

As described herein, a pairing and/or an unpairing gesture may include a predefined motion performed by the user. For example, the pairing and/or unpairing gesture may include shaking the vaporizer device 100 for at least 6 seconds. In some embodiments, the mobile application 303 may control and/or detect the pairing and/or unpairing gesture. For example, the mobile application 303 may define the duration of the shaking of the vaporizer device that causes the erase of the shared key being used to secure communications and/or anonymize advertisements between the vaporizer device 100 and the user equipment 302.

In response to detecting the reset indication and/or pairing gesture, the vaporizer device 100 may terminate the binding and/or pairing with the user equipment 302. The vaporizer device 100 may terminate the binding by invalidating, discarding, and/or erasing the locally stored shared key, mobile identifier, device identifier, and/or other parameters associated with the binding to the user equipment 302. Terminating the binding and/or pairing causes the session or connection between the vaporizer 100 and user equipment 302 to end. As such, the vaporizer device 100 may no longer be bound to the user equipment 302. As described above with respect to FIG. 3, the vaporizer device 100 may perform one or more aspects of sending advertisements to indicate the vaporizer device 100 is available for discovery and pairing and/or binding.

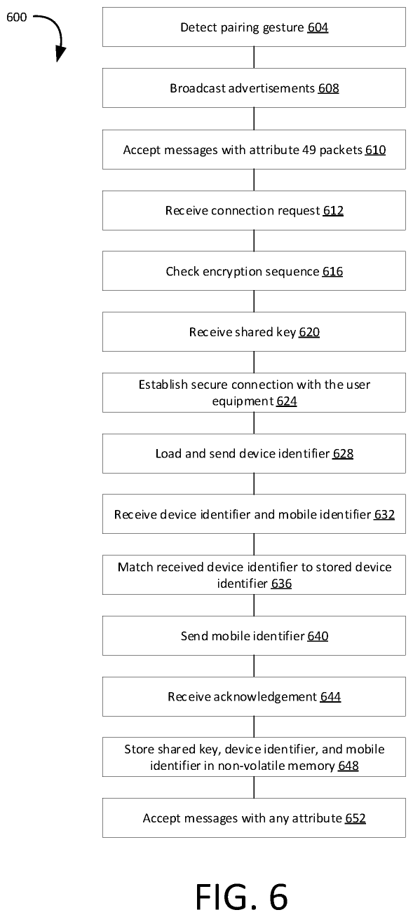

FIG. 6 depicts a flowchart illustrating an example of a process 600 for anonymizing advertisement messages, in accordance with some example embodiments. In some example implementations, the process 600 may illustrate activity that takes place at a vaporizer device during an initial pairing and/or binding process.

At 604, a vaporizer device, such as vaporizer device 100, may detect a pairing gesture. As noted, the vaporizer device may detect that the vaporizer device is being shaken, e.g., by a user.

At 608, a vaporizer device may, from time to time, broadcast one or more advertisement messages. The advertisements may include identifying data about the vaporizer device and/or other private information. For example, as shown above in Table 1, an advertisement may include a device name, a model number, a manufacturer, a device serial number, and/or the like. As noted, the advertisements may include Bluetooth advertisements in accordance with the Bluetooth Specification.

At 610, the vaporizer device may accept messages that include specific attributes and/or parameters. In the Bluetooth example, the vaporizer device may accept messages that include a pairing key attribute, such as attribute 49. As noted, pairing key attribute may indicate the message includes other attributes and/or parameters, such as a shared key, a pairing key, and/or the like.

At 612, the vaporizer device may receive, from the user equipment and in response to the advertisement broadcast at 608, a connection request. In the case of Bluetooth, the vaporizer device may receive from the user equipment a connection request in the form of a Bluetooth CONNECT_REQ message. The vaporizer device may then receive, from the user equipment, one or more Bluetooth Pairing Request messages, among other Bluetooth messages. In response, the vaporizer device 100 may send one or more Bluetooth Pairing Response messages, among other Bluetooth messages.

At 616, the vaporizer device may check an encryption sequence. As noted, to check the encryption sequence, the vaporizer device may compare attributes and/or parameters exchanged with the user equipment. Checking the encryption sequence may include comparing last nonces, device identifiers, mobile identifiers, and/or the like.

At 620, the vaporizer device may receive a shared key. The shared key may be used to provide secure communications over the connection established at 612 between the vaporizer device and the user equipment. As noted, the shared key may refer to at least one cryptographic key used by a cryptographic algorithm to encrypt and/or decrypt data. The shared key may be valid for a period of time, such as over a period of one or more sessions between the vaporizer device and the user equipment. The shared key may be valid for secure communications over the established connection 612 until the vaporizer device invalidates and/or erases the locally stored shared key. Alternatively, and/or additionally, the shared key may be valid for secure communications over the established connection 612 until the vaporizer device receives a new shared key from the user equipment. In the case of Bluetooth, the vaporizer device may receive the shared key in a message that includes a pairing key attribute, such as attribute 49. The shared key may enable the vaporizer device and the user equipment to establish a secure a Bluetooth connection. This secure connection may be established across multiple sessions of connections and re-connections, without having to generate and send a new shared key.

At 624, the vaporizer device may establish a secure connection with the user equipment. The connection between the user equipment and the vaporizer device may be secured based on the shared key received at 620. As noted, in the case of Bluetooth for example, the vaporizer device and user equipment may secure (e.g., via encryption and decryption based on the shared key) at least some (if not all) of the data exchanged via the Bluetooth connection established at 624. The encryption and decryption may be applied to the entire payload of each Bluetooth packet. Alternatively, and/or additionally, the encryption and decryption may be applied to the Bluetooth services at the vaporizer device and/or the user equipment.

At 628, the vaporizer device may load a locally stored device identifier and send it to the user equipment. For example, the device identifier may be stored in the vaporizer device in non-volatile memory when the vaporizer device is manufactured, distributed, and/or sold. The vaporizer device may later use the device identifier to determine whether the vaporizer device is bound to the user equipment. As noted, in the case of Bluetooth, the device identifier may be a 48 bit Bluetooth Device Address (BD_ADDR) that includes a manufacturer identifier and a media access control (MAC) address.

At 632, the vaporizer device may receive a device identifier and mobile identifier from the user equipment. The device identifier may be provided by the user equipment to confirm the user equipment correctly received the device identifier at 628. As noted, the mobile identifier may be a random number generated by the user equipment. It may be of sufficient length to uniquely identify the user equipment from among other devices that may come within range of the vaporizer device.

At 634, the vaporizer device may match the received device identifier against the locally stored device identifier. If the received device identifier matches the locally store device identifier, at 640 the vaporizer device may send the mobile identifier to the user equipment. By sending the mobile identifier to the user equipment, the vaporizer device may indicate it has successfully received the mobile identifier and may confirm that the vaporizer device is bound to the user equipment.

At 644, the vaporizer device may receive an acknowledgement. The acknowledgement may indicate that the binding between the vaporizer device and the user equipment is complete.

At 648, the vaporizer device may store the shared key, device identifier, mobile identifier, and/or other parameters associated with the connection to the user equipment (e.g., locally and/or in non-volatile memory).

At 652, the vaporizer device may accept messages containing any attribute. As noted, attributes may include attributes that control the function and/or appearance of the vaporizer device. Attributes may include heater set point attributes, color theme attributes, name attributes, session size attributes, dosage attributes, and/or the like.

After the vaporizer device is bound to the user equipment, the vaporizer device may be configured to only re-connect to the user equipment until the binding is terminated.

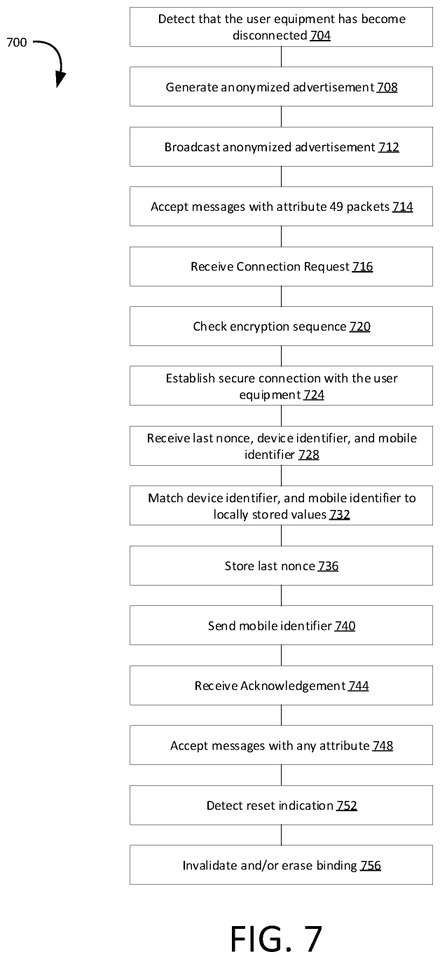

FIG. 7 depicts another flowchart illustrating an example of a process 700 for anonymizing advertisement messages, in accordance with some example embodiments.

At 704, after binding to the user equipment, as described above with respect to FIG. 6, the vaporizer device may detect that the user equipment has become disconnected. The user equipment become disconnected if one or more of the following occurs: the user equipment is powered off, the vaporizer device moves out of the wireless range of the user equipment (or vice versa), or for other reasons. Because the vaporizer device is still bound to the user equipment, the vaporizer device may have the locally stored shared key, device identifier, mobile identifier, and other parameters associated with the binding to the user equipment, as described above with respect to FIG. 6. As such, the vaporizer may begin broadcasting anonymized advertisements to allow the user equipment to re-establish a connection. The anonymized advertisement may include the device identifier, mobile identifier, and other parameters associated with the binding to the user equipment.

At 708, the vaporizer device may generate an anonymized advertisement. As noted, the anonymized advertisement may include a masked device identifier of the vaporizer device. As discussed above with respect to FIG. 4, the vaporizer device may generate the anonymized advertisement by masking at least a portion of the advertisement, while not masking other portions of the advertisement. To anonymize a Bluetooth advertisement for example, the vaporizer device may mask one or more of the Bluetooth fields listed in Table 1, but not mask the other Bluetooth fields included in the advertisement. As noted, the vaporizer device may apply one or more masking techniques as described above with respect to 408.

The vaporizer device may include an indicator (e.g., a flag or a bit) in the advertisement. The indicator may provide a hint to the user equipment as to whether the advertisement is anonymized. If the advertisement is anonymized (e.g., if the vaporizer device is bound to the user equipment), the vaporizer device may set the indicator, so that when the advertisement is received at the user equipment, the user equipment can detect, from the indicator, that the advertisement needs additional processing to unmask at least a portion of the advertisement. On the other hand, if the advertisement does not include any portion that is anonymized, the vaporizer device may clear the indicator so that when the advertisement is received, the user equipment can detect that additional processing to unmask can be by-passed. For example, an indicator setting of “1” may indicate to the user equipment that the advertisement needs additional processing to unmask at least a portion of the advertisement, but an indicator setting of “0” may indicate to the user equipment that the advertisement does not additional processing to unmask at least a portion of the advertisement.

At 712, the vaporizer device may, from time to time, broadcast the anonymized advertisement. For example, the vaporizer device may periodically broadcast the anonymized Bluetooth or Bluetooth Low Energy advertisement to allow another device, such as the user equipment, to discover the vaporizer device.

At 714, the vaporizer device may accept messages containing specific attributes and/or parameters. In the Bluetooth example, the vaporizer device may accept messages that include a pairing key attribute, such as attribute 49. As noted, the pairing key attribute may indicate the message includes other attributes and/or parameters, such as a shared key, a pairing key, and/or the like.

At 716, the vaporizer device may receive a connection request. In the case of Bluetooth for example, the vaporizer device may receive a Bluetooth CONNECT_REQ.

At 720, the vaporizer device may check an encryption sequence. As noted, to check the encryption sequence, the vaporizer device may compare attributes and/or parameters exchanged with the user equipment. Checking the encryption sequence may include comparing last nonces, device identifiers, mobile identifiers, and/or the like.

At 724, a secure connection may be re-established between vaporizer device and the user equipment. As described above with respect to 620, the vaporizer device and the user equipment may each have the shared key that may be used to secure communications between the vaporizer device and the user equipment. In the case of Bluetooth, the vaporizer device and user equipment may secure (e.g., via encryption and decryption based on the shared key) at least some (if not all) of the data exchanged via the Bluetooth connection established at 724. The encryption and decryption may be applied to the entire payload of each Bluetooth packet. Alternatively, and/or additionally, the encryption and decryption may be applied to the Bluetooth services at the vaporizer device and/or the user equipment.

At 728, the vaporizer device may receive a last nonce, a device identifier, a mobile identifier, and/or other parameters from the user equipment.

At 732, the vaporizer device may match the received device identifier, received mobile identifier, and/or other received parameters to locally stored values. As described above with respect to FIG. 6, the device identifier, mobile identifier, shared key, and/or other parameters may have been stored locally, at 648, when the vaporizer device was bound to the user equipment. If the received values match the locally stored values, the vaporizer device may determine it is bound to the user equipment.

At 736, the vaporizer device may store the received last nonce value (e.g., locally and/or in non-volatile memory).

At 740, the vaporizer device may send the mobile identifier to the user equipment. By sending the mobile identifier, the vaporizer device may indicate it has determined that the vaporizer device is bound to the user equipment.

At 744, the vaporizer device may receive an acknowledgement from the user equipment. The acknowledgement may indicate that the user equipment has also determined the vaporizer device is bound to the user equipment. After the vaporizer device has determined that it is bound to the user equipment, the vaporizer device may continue to communicate with the user equipment over the secure communication session.

At 748, the vaporizer device may accept messages containing any attributes. As noted, the attributes may include attributes that control the function and/or appearance of the vaporizer device. Attributes may include heater set point attributes, color theme attributes, name attributes, session size attributes, dosage attributes, and/or the like.

At 752, the vaporizer device may detect a reset indication. The user of the vaporizer device may issue the reset indication, for example, in to order terminate the current binding and/or pairing with the user equipment and/or to initiate a pairing and/or binding with a different user equipment. As noted, the reset indication may include a gesture by the user, a user input, a message from the user equipment, and/or the like. For example, the vaporizer device may determine, based on accelerometer readings, that the vaporizer device is being shaken for a threshold amount of seconds, e.g., 2 seconds.

At 756, the vaporizer device may invalidate and/or erase the binding with the user equipment. To invalidate and/or erase the binding, the vaporizer device may invalidate and/or erase the locally stored shared key, device identifier, mobile identifier, and/or other parameters associated with the pairing and/or binding. After invalidating and/or erasing the pairing and/or binding, the vaporizer device may start sending advertisements to indicate it is available for pairing and/or binding, as described above with respect to FIG. 6.

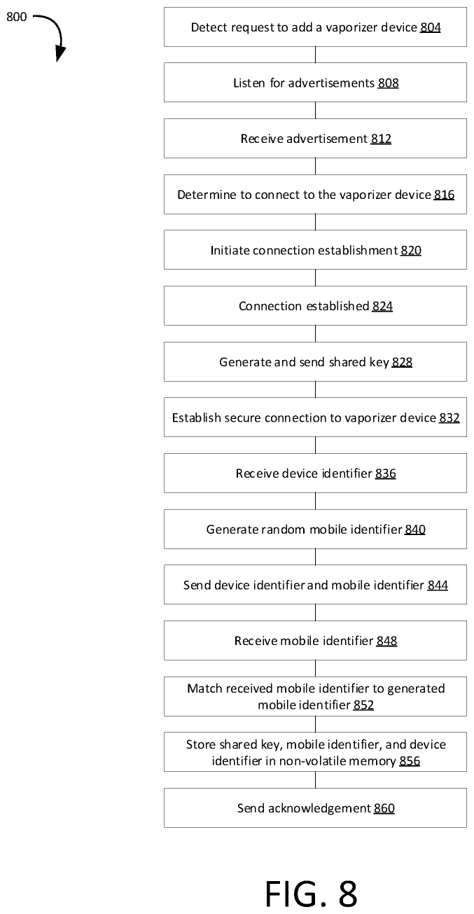

FIG. 8 depicts a flowchart illustrating an example of another process 800 for anonymizing advertisement messages, in accordance with some example embodiments. In some example implementations, the process 800 may illustrated activity that takes place at a user equipment during an initial pairing and/or binding process.

At 804, a user equipment, such as the user equipment 302, may detect a request to add a vaporizer device. As noted, the user may indicate this request by selecting a menu item, pressing a button, making a gesture, and/or the like.

At 808, the user equipment may listen for advertisements. In the case of Bluetooth Low Energy, the user equipment may listen for Bluetooth Low Energy advertisements.

At 812, the user equipment may receive an advertisement message. As described above with respect to Table 1, the advertisement message may include identifying data associated with the vaporizer device, and/or the user equipment. To illustrate via a Bluetooth example, at 812 the user equipment may receive a Bluetooth advertisement from the vaporizer device. This Bluetooth advertisement may include one or more elements that include identifying data (as shown in Table 1) about the vaporizer device, a user, or the user equipment associated with the user or vaporizer.

At 816, the user equipment, or the mobile application running on the user equipment, may determine, based on the contents of the advertisement, to initiate a connection with the vaporizer device. The user equipment may determine that the advertisement includes a device identifier, a model number, a serial number, a service universally unique identifier (UUID), manufacturer-specific data, and/or other parameters that have a format and/or value recognized by the user equipment. The user equipment may display at least some of the identifying data on a user interface display. The user equipment may detect a user selection to connect to the vaporizer device. The user equipment may locally store at least some of the identifying data included in the advertisement. For example, if the advertisement includes a device identifier, the user equipment may locally store the device identifier. As will be described further, the user equipment may later determine, based on the locally stored identifying data, whether to re-establish a connection with the vaporizer device.

At 820, the user equipment may initiate connection establishment with the vaporizer device by sending a connection request to the vaporizer device. In the case of Bluetooth, the user equipment may initiate connection establishment by sending a Bluetooth CONNECT_REQ message to the vaporizer device.

At 824, the user equipment may establish a connection with the vaporizer device. In the case of Bluetooth, the user equipment may receive a Bluetooth CONNECT_RESP message. The user equipment may pair with the vaporizer device by sending, to the vaporizer device, one or more Bluetooth Pairing Request messages (among other messages) and receiving, from the vaporizer device, one or more Pairing Response messages (among other messages).

At 828, as noted, the user equipment may generate a shared key and send it to the vaporizer device. The shared key may be used to provide secure communication between the vaporizer device and the user equipment. In the case of Bluetooth, the user equipment may send the shared key to the vaporizer device in a message that includes a pairing key attribute, such as attribute 49. Messages that include the pairing key attribute may include other attributes and/or parameters, such as a shared key and/or a pairing key.

At 832, the user equipment may establish a secure connection to the vaporizer device. The connection may be secured based on the shared key received, for example, at 828. As noted, the shared key may be used to provide secure communications between the vaporizer device and the user equipment. In the case of Bluetooth for example, the vaporizer device and user equipment may secure (e.g., via encryption and decryption based on the shared key) at least some (if not all) of the data exchanged via the Bluetooth connection established at 832. The encryption and decryption may be applied to the entire payload of each Bluetooth packet. Alternatively, and/or additionally, the encryption and decryption may be applied to the Bluetooth services at the vaporizer device and/or the user equipment

At 836, the user equipment may receive a device identifier from the vaporizer device. As noted, the user equipment may later use the device identifier to determine whether to re-establish communications with the vaporizer device.

At 840, the user equipment may generate a random mobile identifier. As noted, the user equipment and/or vaporizer device may later use the mobile identifier to determine that the vaporizer device is bound to the user equipment.

At 844, the user equipment may send the device identifier and mobile identifier to the vaporizer device. As noted, the user equipment may later use the mobile identifier to determine whether to re-establish communications with the vaporizer device.

At 848, the user equipment may receive a mobile identifier from the vaporizer device.

At 852, the user equipment may match the received mobile identifier to the generated mobile identifier. If the received mobile identifier matches the generated mobile identifier, at 856 the user equipment may locally store the shared key, mobile identifier, device identifier, and/or other parameters associated with the connection to the vaporizer device (e.g., in non-volatile memory).

One or more vaporizer devices may be bound to the user equipment at any given time. As such, the user equipment may locally store (e.g., in non-volatile memory), a binding record associated with each vaporizer device. Each binding record may include a shared key, a device identifier, a mobile identifier, and other parameters associated with the connection to the vaporizer device. For example, if two vaporizer devices are bound to the user equipment, the user equipment may store a first binding record associated with the first vaporizer device and a second binding record associated with the second vaporizer device. The first binding record may include a first shared key, a first device identifier, a first mobile identifier, and/or the like. The second binding record may include a second shared key, a second device identifier, a second mobile identifier, and/or the like. Any number of vaporizer devices may be bound to the user equipment, so the user equipment may locally store any number of binding records, one for each associated vaporizer device.

At 860, the user equipment may send an acknowledgement to the vaporizer device. The acknowledgement may indicate, to the vaporizer device, that the vaporizer device is bound to the user equipment. After the user equipment and vaporizer device are paired and/or bound, the user equipment may continue to send messages to and receive messages from the vaporizer device via the secure connection.

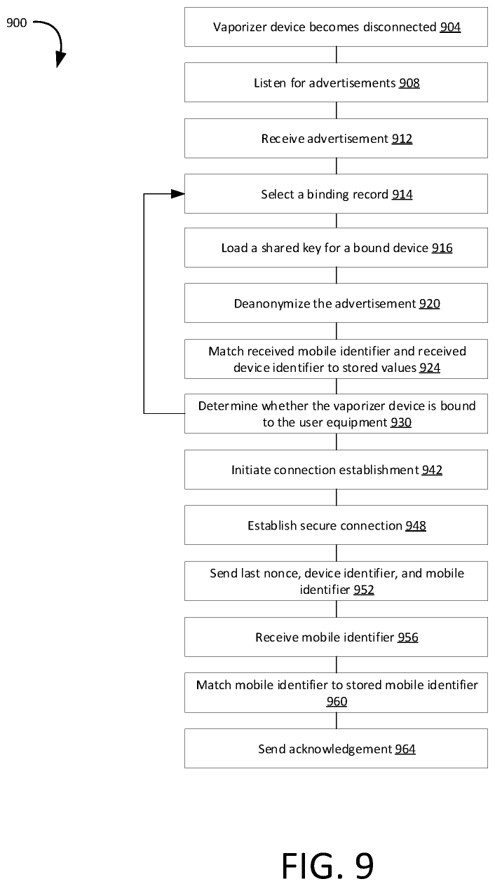

FIG. 9 depicts a flowchart illustrating an example of another process 900 for anonymizing advertisement messages, in accordance with some example embodiments.

At 904, the vaporizer device may become disconnected from the user equipment. For example, the vaporizer device may be powered off, the user equipment may be powered off and then on, the user equipment may move out of range of the vaporizer device (or vice versa), or for other reasons may cause a loss of the Bluetooth connection, for example.

At 908, the user equipment may begin listening for advertisements. The user equipment may begin listening for advertisements as a result of detecting that the vaporizer device has become disconnected. The user equipment may receive a request to re-establish a connection with the vaporizer device. The user may indicate this request by selecting a menu item, pressing a button, making a gesture, and/or the like.

At 912, the user equipment may receive an advertisement. As described above with respect to 412, the vaporizer device may broadcast anonymized advertisements if it detects that it has become disconnected from the user equipment. As such, the advertisement may be an anonymized advertisement sent by a vaporizer device. As noted, the vaporizer device may broadcast advertisements that are not anonymized after the vaporizer device detects a pairing gesture and/or a reset indication. As such, the advertisement received at 912 may or may not be anonymized.

As noted above with respect to 708, the advertisement may include masked identifying data (e.g., encrypted, ciphered, encoded, scrambled, and/or the like). The user equipment may determine whether the advertisement is anonymized by unmasking the identifying data (e.g., decrypting, deciphering, decoding, unscrambling, and/or the like). The user equipment may then compare the unmasked identifying data against locally stored values, such as the identifying data received from the vaporizer device and stored in the binding records. If the unmasked identifying data matches the locally stored values, the user equipment may determine that a binding already exists for the vaporizer device. Referring to the example of FIG. 5, the user equipment may determine whether the advertisement 500 is anonymized by unmasking (e.g., decrypting, deciphering, decoding, unscrambling, and/or the like) the masked device identifier at 540C based on a shared key from a locally stored binding record. If the user equipment determines that the received device identifier matches the locally stored value (e.g., 0x123456789012), the user equipment may determine that a binding exists for the vaporizer device that sent the advertisement message. As noted, the user equipment does not need to unmask other fields of the advertisement 500 (e.g., 520A-C, 530A-C, and 540A-B), because those fields may not contain identifying data.

As noted, the vaporizer device may include an indicator (e.g., a flag or a bit) in the advertisement. The indicator may provide a hint to the user equipment regarding whether the advertisement is anonymized. If the second advertisement is anonymized, the indicator may be set (e.g., set to “1”). On the other hand, if the second advertisement is not anonymized, the indicator may be cleared (e.g., set to “0”). If indicator is cleared, user equipment may handle the advertisement as a non-anonymized advertisement from new vaporizer device, as described above with respect to FIG. 8.

At 914, the user equipment may select a binding record (e.g., from local and/or non-volatile memory). As noted, more than one vaporizer device may be bound to the user equipment at any given time. As such, the user equipment may store a binding record associated with each vaporizer device. Each binding record may include a shared key, a device identifier, a mobile identifier, and/or other information associated with a particular vaporizer device.

At 916, the user equipment may load a shared key from the selected binding record.

At 920, the user equipment may deanonymize the received advertisement using the shared key. As noted, to deanonymize the second advertisement, the user equipment may unmask (e.g., decrypt, unscramble, decipher, decode, and/or the like) the identifying data contained in the advertisement. Since the other portions of the second advertisement (e.g., the portions that do not contain identifying data) are not masked, the user equipment does not need to unmask those other portions of the advertisement.

At 924, the user equipment may match the identifying data from the received advertisement to the locally stored values. For example, the user equipment may match the device identifier from the received advertisement to the device identifier from the selected binding record, and the user equipment may match the mobile identifier from the received advertisement to the mobile identifier from the selected binding record.

At 930, the user equipment may determine whether the vaporizer device is bound to the user equipment. If the identifying data from the received advertisement is different from the locally stored values, the user equipment may determine that the advertisement came from a vaporizer device that has a different binding with the user equipment. As such, the user equipment may continue by selecting another binding record as described above with respect to 914. For example, if the device identifier from the received advertisement is different from the device identifier from the selected binding record, or if the mobile identifier from the received advertisement is different from the mobile identifier from the selected binding record, the user equipment may continue by selecting a different binding record, as described above with respect to 914.

Alternatively, and/or additionally, if the identifying data from the received advertisement is different from the identifying data in the selected binding record, the advertisement may have been sent by a vaporizer device that is not bound to the user equipment. After checking the received advertisement against the stored bindings, the user equipment may determine that the advertisement is from a vaporizer device that is not bound to the user equipment, and may continue by processing the advertisement as a non-anonymized advertisement, as discussed above with respect to FIG. 8.

Alternatively, and/or additionally, if the identifying data from the received advertisement matches the locally stored values, the user equipment may, at 942, initiate a connection establishment and/or re-establishment with the vaporizer device. For example, if the device identifier from the received advertisement matches the device identifier from the selected binding record, and if the mobile identifier from the received advertisement matches the mobile identifier from the selected binding record, the user equipment may, at 942, continue by initiating a connection establishment with the vaporizer device. In the case of Bluetooth, the user equipment may, at 942, send a CONNECT_REQ message to the vaporizer device.

At 948, the user equipment may establish a secure connection with the vaporizer device. As noted, the vaporizer device may be bound to the user equipment. As such, the user equipment and vaporizer device may each have a shared key with which to secure the connection. In the case of Bluetooth for example, the vaporizer device and user equipment may secure (e.g., via encryption and decryption based on the shared key) at least some (if not all) of the data exchanged via the Bluetooth connection established at 948. The encryption and decryption may be applied to the entire payload of each Bluetooth packet. Alternatively, and/or additionally, the encryption and decryption may be applied to the Bluetooth services at the vaporizer device and/or the user equipment.

At 952, the user equipment may send a last nonce, device identifier, and mobile identifier to the vaporizer device. By sending these parameters to the vaporizer device, the user equipment may indicate, to the vaporizer device, that vaporizer device may be bound to the user equipment.

At 956, the user equipment may receive a mobile identifier from the vaporizer device. By sending the mobile identifier to the user equipment, the vaporizer device may confirm that the vaporizer device is bound to the user equipment.

At 960, the user equipment may match the received mobile identifier to the mobile identifier locally stored in the selected binding record. If the received mobile identifier matches the locally stored value, the user equipment may determine that the vaporizer device is bound to the user equipment.

At 964, the user equipment may send an acknowledgement to the vaporizer device. The acknowledgement may indicate, to the vaporizer device, that the user equipment has confirmed the vaporizer device is bound to the user equipment.

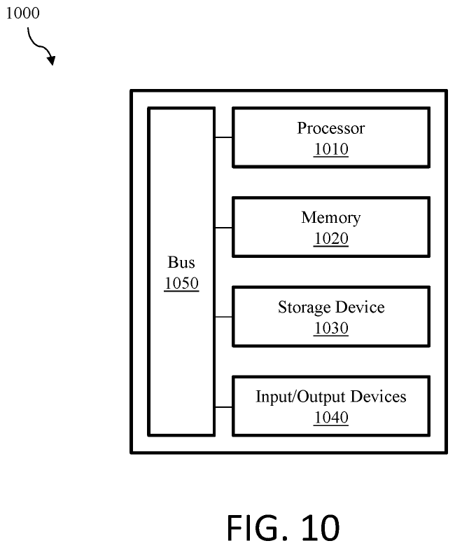

FIG. 10 depicts a block diagram illustrating a computing system 1000, in accordance with some example embodiments. Referring to FIGS. 1-5, the computing system 1000 may be used to implement the user equipment 302.

As shown in FIG. 10, the computing system 1000 can include a processor 1010, a memory 1020, a storage device 1030, and input/output devices 1040. The processor 1010, the memory 1020, the storage device 1030, and the input/output devices 1040 can be interconnected via a system bus 850. The processor 1010 is capable of processing instructions for execution within the computing system 1000. Such executed instructions can implement one or more operations of the vaporizer device 100 and/or the user equipment 302. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet). The input/output device 1040 may be capable of operating with one or more air interface standards, communication protocols, modulation types, access types, and/or the like. The input/output device 1040 may be capable of operating with one or more air interface standards, communication protocols, modulation types, access types, and/or the like. the input/output device 1040 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols, session initiation protocol (SIP) and/or the like. The input/output device 1040 may be capable of operating in accordance with 2G wireless communication protocols (e.g., IS-136), Time Division Multiple Access (TDMA), Global System for Mobile communications (GSM), Intermediate Standard 95 (IS-95), Code Division Multiple Access, (CDMA), and/or the like. The input/output device 1040 may be capable of operating in accordance with 2.5G wireless communication protocols General Packet Radio Service (GPRS), Enhanced Data GSM Environment (EDGE), and/or the like. The input/output device 1040 may be capable of operating in accordance with 3G wireless communication protocols, such as, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The input/output device 1040 may be capable of operating in accordance with 3.9G wireless communication protocols, such as, Long Term Evolution (LTE), Evolved Universal Terrestrial Radio Access Network (E-UTRAN), and/or the like. The input/output device 1040 may be capable of operating in accordance with 4G wireless communication protocols, such as LTE Advanced and/or the like as well as similar wireless communication protocols that may be subsequently developed.

Vaporizer devices consistent with the current subject matter may be referred to by various terms such as inhalable aerosol devices, aerosolizers, vaporization devices, electronic vaping devices, electronic vaporizers, vape pens, etc. Examples of vaporizer devices consistent with implementations of the current subject matter include electronic vaporizers, electronic cigarettes, e-cigarettes, or the like. In general, such vaporizer devices are often portable, hand-held devices that heat a vaporizable material to provide an inhalable dose of the material. The vaporizer device may include a heater configured to heat a vaporizable material which results in the production of one or more gas-phase components of the vaporizable material.

In various implementations, the vaporizer device may be configured for use with liquid vaporizable material (e.g., a carrier solution in which an active and/or inactive ingredient(s) are suspended or held in solution or a liquid form of the vaporizable material itself) or solid vaporizable material. Solid vaporizable material may include a plant material that emits some part of the plant material as the vaporizable material (e.g., such that some part of the plant material remains as waste after the vaporizable material is emitted for inhalation by a user) or optionally may be a solid form of the vaporizable material itself such that all of the solid material may eventually be vaporized for inhalation. Liquid vaporizable material may likewise be capable of being completely vaporized or may include some part of the liquid material that remains after all of the material suitable for inhalation has been consumed.

Additionally, and/or alternatively, the vaporizable material may include liquid and/or oil-type plant-based smokable materials such as cannabis, a semi-solid like a wax, solid/liquid (e.g., suspensions, liquid-coated) materials, and/or a solid material, such as plant material including loose-leaf materials, leaves or flowers, either raw or processed. The vaporizable material may additionally, and/or alternatively include concentrates (e.g., cannabis concentrates including wax, shatter, budder, butane hash oil, and the like).

In some examples, the vaporizable material may include a viscous liquid such as, for example a cannabis oil. In some variations, the cannabis oil comprises between 0.3% and 100% cannabis oil extract. The viscous oil may include a carrier for improving vapor formation, such as, for example, propylene glycol, glycerol, medium chain triglycerides (MCT) including lauric acid, capric acid, caprylic acid, caproic acid, etc., at between 0.01% and 25% (e.g., between 0.1% and 22%, between 1% and 20%, between 1% and 15%, and/or the like). In some variations the vapor-forming carrier is 1,3-Propanediol. A cannabis oil may include a cannabinoid or cannabinoids (natural and/or synthetic), and/or a terpene or terpenes derived from organic materials such as for example fruits and flowers. For example, any of the vaporizable materials described herein may include one or more (e.g., a mixture of) cannabinoid including one or more of: CBG (Cannabigerol), CBC (Cannabichromene), CBL (Cannabicyclol), CBV (Cannabivarin), THCV (Tetrahydrocannabivarin), CBDV (Cannabidivarin), CBCV (Cannabichromevarin), CBGV (Cannabigerovarin), CBGM (Cannabigerol Monomethyl Ether), Tetrahydrocannabinol, Cannabidiol (CBD), Cannabinol (CBN), Tetrahydrocannabinolic Acid (THCA), Cannabidioloc Acid (CBDA), Tetrahydrocannabivarinic Acid (THCVA), one or more Endocannabinoids (e.g., anandamide, 2-Arachidonoylglycerol, 2-Arachidonyl glyceryl ether, N-Arachidonoyl dopamine, Virodhamine, Lysophosphatidylinositol), and/or a synthetic cannabinoids such as, for example, one or more of: JWH-018, JWH-073, CP-55940, Dimethylheptylpyran, HU-210, HU-331, SR144528, WIN 55,212-2, JWH-133, Levonantradol (Nantrodolum), and AM-2201. The oil vaporization material may include one or more terpene, such as, for example, Hemiterpenes, Monoterpenes (e.g., geraniol, terpineol, limonene, myrcene, linalool, pinene, Iridoids), Sesquiterpenes (e.g., humulene, farnesenes, farnesol), Diterpenes (e.g., cafestol, kahweol, cembrene and taxadiene), Sesterterpenes, (e.g., geranylfarnesol), Triterpenes (e.g., squalene), Sesquarterpenes (e.g, ferrugicadiol and tetraprenylcurcumene), Tetraterpenes (lycopene, gamma-carotene, alpha- and beta-carotenes), Polyterpenes, and Norisoprenoids. For example, an oil vaporization material as described herein may include between 0.3-100% cannabinoids (e.g., 0.5-98%, 10-95%, 20-92%, 30-90%, 40-80%, 50-75%, 60-80%, etc.), 0-40% terpenes (e.g., 1-30%, 10-30%, 10-20%, etc.), and 0-25% carrier (e.g., medium chain triglycerides (MCT)).

In any of the oil vaporizable materials described herein (including in particular, the cannabinoid-based vaporizable materials), the viscosity may be within a predetermined range. The range may be between, at room temperature (23° C.) about 30 cP (centipoise) and 115 kcP (kilocentipoise), between 30 cP and 200 kcP, although higher viscosities and/or lower viscosities may be implemented as well. For example, the viscosity may be between 40 cP and 113 kcP at room temperature. Outside of this range, the vaporizable material may fail in some instances to wick appropriately to form a vapor as described herein. In particular, it is typically desired that the oil may be made sufficiently thin to both permit wicking at a rate that is useful with the apparatuses described herein, while also limiting leaking (e.g., viscosities below that of ˜40 cP at room temperature might result in problems with leaking).

One or more aspects or features of the subject matter described herein can be realized in digital electronic circuitry, integrated circuitry, specially designed application-specific integrated circuit (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively, and/or additionally, store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

Although the disclosure, including the figures, described herein may described and/or exemplify these different variations separately, it should be understood that all or some, or components of them, may be combined.

Although some of the examples above refer to Bluetooth, the anonymizing of advertisements may be used with other peer-to-peer, short-range, or low power radio technologies, such as Wi-Fi Direct, Zigbee, 6LoWPAN, Zwave, ANT network and/or the like.

Although various illustrative embodiments are described above, any of a number of changes may be made to various embodiments. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the claims.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. References to a structure or feature that is disposed “adjacent” another feature may have portions that overlap or underlie the adjacent feature.

Terminology used herein is for the purpose of describing particular embodiments only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as, for example, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

Throughout this specification and the claims which follow, unless the context requires otherwise, the word “comprise”, and variations such as “comprises” and “comprising” means various components can be co jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” “or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, are possible.

In the descriptions above and in the claims, phrases such as, for example, “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A vaporizer device, comprising:
at least one data processor; and
at least one memory storing instructions which, when executed by the at least one data processor, cause the vaporizer device to at least:
anonymize at least a portion of an advertisement, the portion including data identifying at least one of the vaporizer device and a user equipment associated with the vaporizer device; and
transmit, to one or more devices including the user equipment, the anonymized advertisement.

2. The vaporizer device of claim 1, wherein the user equipment includes an application for configuring the vaporizer device.

3. The vaporizer device of claim 2, wherein the vaporizer device is further caused to at least anonymize at least the portion of the advertisement by masking one or more fields of the advertisement while leaving at least one field of the advertisement in plaintext.

4. The vaporizer device of claim 3, wherein the vaporizer device is further caused to at least mask the one or more fields based on a cryptographic algorithm.

5. The vaporizer device of claim 4, wherein the cryptographic algorithm is configured to encrypt the one or more fields, cipher the one or more fields, scramble the one or more fields, and/or encode the one or more fields.

6. The vaporizer device of claim 4, wherein the cryptographic algorithm receives as an input, the one or more fields in plaintext and one or more shared keys, and wherein the cryptographic algorithm provides as an output, the one or more fields in cipher text.

7. The vaporizer device of claim 1, wherein the vaporizer device is further caused to at least:
receive a connection request from the user equipment; and
establish, in response to the connection request being received, a secure connection with the user equipment, wherein the secure connection is secured based on one or more locally stored shared keys, and wherein the one or more locally stored shared keys are exchanged with the user equipment prior to the anonymized advertisement being transmitted by the vaporizer device.

8. The vaporizer device of claim 7, wherein the vaporizer device is further caused to at least:
detect a reset indication; and
erase, in response to the reset indication being detected, the one or more locally stored shared keys.

9. The vaporizer device of claim 8, wherein the reset indication comprises a shaking gesture.

10. The vaporizer device of claim 7, wherein the one or more locally stored shared keys comprises application layer shared keys.

11. The vaporizer device of claim 1, wherein the data identifying at least one of the vaporizer device and the user equipment associated with the vaporizer device comprises an identifier of the vaporizer device, an identifier of a manufacturer of the vaporizer device, or a combination thereof.

12. The vaporizer device of claim 1, wherein to anonymize the advertisement wherein the vaporizer device is further caused to at least include an anonymized indicator in the advertisement.

13. The vaporizer device of claim 1, wherein the advertisement comprises one or more of: a Bluetooth low energy advertisement, and a beacon.

14. A method, comprising:
anonymizing at least a portion of an advertisement, the portion including data identifying at least one of the vaporizer device and a user equipment associated with the vaporizer device; and
transmitting, to one or more devices including a user equipment, the anonymized advertisement.

15. The method of claim 14, wherein the user equipment includes an application for configuring the vaporizer device.

16. The method of claim 15, further comprising anonymizing at least the portion of the advertisement by masking one or more fields of the advertisement while leaving at least one field of the advertisement in plaintext.

17. The method of claim 16, further comprising masking the one or more fields based on a cryptographic algorithm.

18. The method of claim 17, wherein the cryptographic algorithm is configured to encrypt the one or more fields, cipher the one or more fields, scramble the one or more fields, and/or encode the one or more fields.

19. The method of claim 17, wherein the cryptographic algorithm receives as an input the one or more fields in plaintext and one or more shared keys, and wherein the cryptographic algorithm provides as an output the one or more fields in cipher text.

20. The method of claim 14, further comprising:
receiving a connection request from the user equipment; and
establishing, in response to the connection request being received, a secure connection with the user equipment, wherein the secure connection is secured based on one or more locally stored shared keys, and wherein the one or more shared keys are exchanged with the user equipment prior to the anonymized advertisement being transmitted by the vaporizer device.
